(19) United States
(12) Patent Application Publication
(10) Pub. No.: US 2007/0112081 A1
(43) Pub. Date: May 17, 2007

(54) Moldable-foam moldings composed of expandable styrene polymers and mixtures with thermoplastic polymers

(75) Inventors: Klaus Hahn, Kirchhelm (DE); Gerd Ehrmann, Deidesheim (DE); Joachim Ruch, Wachenheim (DE); Markus Allmendinger, Meckenheim (DE); Bernhard Schmied, Frankenthal (DE); Jan Holoch, Leimen (DE); Klaus Muhlbach, Grunstadt (DE); Michael Riethues, Ludwigshafen (DE)

Correspondence Address: CONNOLLY BOVE LODGE & HUTZ, LLP, P O BOX 2207, WILMINGTON, DE, 19899, US

(73) Assignee: BASF Aktiengensellschaft, Ludwigshafen (DE)

(21) Appl. No.: 10/581,948

(22) PCT Filed: Dec. 10, 2004
(86) PCT No.: PCT/EP04/14066

§ 371 Date: Jun. 6, 2006

(30) Foreign Application Priority Data
Dec. 12, 2003 (DE) 10358801.9

(51) Int. Cl. C08J 9/16

(52) U.S. Cl. 521/56

(57) ABSTRACT

Moldable-foam moldings whose density is in the range from 10 to 100 g/l, obtainable via the fusion of prefoamed foam beads composed of expandable, pelletized thermoplastic polymer materials, comprising from 5 to 100% by weight of a styrene copolymer A), from 0 to 95% by weight of polystyrene B), and from 0 to 95% by weight of a thermoplastic polymer C) other than A) and B), and a process for producing the expandable pelletized thermoplastic polymer materials.

The invention relates to moldable-foam moldings whose density is in the range from 10 to 100 g/l, obtainable via the fusion of prefoamed foam beads composed of expandable, pelletized thermoplastic polymer materials, comprising

from 5 to 100% by weight of a styrene copolymer A),

from 0 to 95% by weight of polystyrene B), and

from 0 to 95% by weight of a thermoplastic polymer C) other than A) and B),

and a process for producing the expandable pelletized thermoplastic polymer materials.

A process for preparing expandable styrene polymers, such as expandable polystyrene (EPS) via suspension polymerization has been known for a long time. A disadvantage of these processes is that large amounts of waste water arise and have to be discarded. The polymers have to be dried in order to remove internal water. In addition, the suspension polymerization generally gives broad bead size distributions which require complicated sieving to give various bead fractions.

Extrusion processes can also be used to prepare expanded and expandable styrene polymers. Here, the blowing agent is incorporated by mixing, by way of example, through an extruder into the polymer melt, and the material is passed through a die plate and divided to give particles or strands (U.S. Pat. No. 3,817,669, GB 1,062,307, EP-B 0 126 459, U.S. Pat. No. 5,000,891).

EP-A 668 139 describes a process for the cost-effective preparation of expandable pelletized polystyrene material (EPS) where static mixing elements are used to prepare the melt comprising blowing agent in a dispersion, retention, and cooling stage, and the material is then pelletized. The dissipation of large amounts of heat is required, because the melt is cooled to a few degrees above the solidification point.

Various pelletization processes have been proposed for substantial prevention of post-extrusion foaming, e.g. underwater pelletization (EP-A 305 862), spray mist (WO 03/053651), or atomization (U.S. Pat. No. 6,093,750).

WO 98/51735 describes expandable styrene polymers comprising graphite particles and having reduced thermal conductivity, and obtainable via suspension polymerization or via extrusion in a twin-screw extruder. Because of the high shear forces in a twin-screw extruder, significant molecular weight degradation of the polymer used, and/or some decomposition of additive, such as flame retardant, is/are usually observed.

Factors of decisive importance for giving the foams ideal insulation properties and good surfaces are the number of cells and the foam structure obtained during foaming of the expandable styrene polymers (EPSs). The pelletized EPS materials prepared via extrusion are frequently not capable of foaming to give foams with ideal foam structure.

Expandable, rubber-modified styrene polymers for elastic polystyrene foams are described by way of example in WO 94/25516, EP-A 682 077, DE-A 97 10 442, and EP-A 0 872 513.

It was an object of the present invention to provide expandable pelletized thermoplastic polymer materials which are capable of pre-foaming to give predominantly closed-cell foam beads, even in existing EPS-processing plants, and are capable of fusion to give moldable-foam moldings whose density is in the range from 10 to 100 g/l.

This led to discovery of the moldable-foam moldings described above, whose density is in the range from 8 to 100 g/l, preferably in the range from 15 to 50 g/l. They are obtainable via fusion of prefoamed foam beads composed of expandable, pelletized thermoplastic polymer materials which comprise

from 5 to 100% by weight of a styrene copolymer A),

from 0 to 95% by weight of polystyrene B), and

from 0 to 95% by weight of a thermoplastic polymer C) other than A) and B).

The moldable-foam moldings have a high proportion of closed cells, more than 60%, preferably more than 70%, particularly preferably more than 80%, of the cells in the individual foam beads generally being of closed-cell type.

The pelletized thermoplastic polymer material particularly preferably comprises

from 50 to 90% by weight of polystyrene B) and

from 10 to 50% by weight of styrene copolymer A) or thermoplastic polymer C).

Preferred styrene copolymers A) used are styrene-butadiene block copolymers, styrene-α-methylstyrene copolymer, acrylonitrile-butadiene-styrene (ABS), styrene-acrylonitrile (SAN), acrylonitrile-styrene-acrylate (ASA), methacrylate-butadiene-styrene (MBS), methyl methacrylate-acrylonitrile-butadiene-styrene (MABS) polymers.

The polystyrene B) used may comprise free-radical-polymerized glass-clear polystyrene (GPPS), impact-modified polystyrene (HIPS), or anionically polymerized polystyrene (APS), or anionically polymerized impact-resistant polystyrene (AIPS).

Examples of thermoplastic polymer C) which may be used are polyamide (PA), polyolefins, such as polypropylene (PP) or polyethylene (PE), polyacrylates, such as poly-methyl methacrylate (PMMA), polycarbonate (PC), polyesters, such as polyethylene terephthalate (PET) or polybutylene terephthalate (PBT), polyether sulfone (PES), poly-ether ketones (PEKs), or polyether sulfides (PES), or a mixture of these.

The composition of the pelletized polymer material may be selected to correspond with the desired properties of the moldable-foam molding. Styrene-butadiene block copolymers A) are particularly suitable for improving the elasticity and the resilience of the moldable-foam moldings. Acrylonitrile-containing styrene copolymers, such as SAN and ABS, can be used to improve oil resistance and solvent resistance, in particular with respect to aromatic solvents, and to improve heat resistance.

It has been found that styrene polymers with molecular weights M_{w} below 160 000 lead to polymer abrasion during pelletization. The molar mass of the expandable styrene polymer is preferably in the range from 190 000 to 400 000 g/mol, particularly preferably in the range from 220 000 to 300 000 g/mol. The molar mass of the expandable polystyrene is generally below the molar mass of the polystyrene used by about 10 000 g/mol, because the molecular weight undergoes reduction via shear and/or exposure to heat.

To minimize the size of the particles obtained of pelletized material, die swell downstream of discharge from the die should be minimized. It has been found that die swell can be affected, inter alia, by the molecular weight distribution of the styrene polymer. The expandable styrene polymer should therefore preferably have a molecular weight distribution with polydispersity M_{w}/Mₙ of at most 3.5, particularly preferably in the range from 1.5 to 2.8, and very particularly preferably in the range from 1.8 to 2.6.

Examples of suitable compatibilizers are maleic-anhydride-modified styrene copolymers, polymers containing epoxy groups, and organosilanes.

Recycled polymers comprising the thermoplastic polymers mentioned, in particular styrene polymers and expandable styrene polymers (EPSs) may also be admixed with the styrene polymer melt in amounts which do not substantially impair its properties, generally in amounts of at most 50% by weight, in particular in amounts of 1 to 20% by weight.

The styrene polymer melts comprising blowing agent generally comprises one or more blowing agents homogeneously distributed in a total proportion of from 2 to 10% by weight, preferably from 3 to 7% by weight, based on the styrene polymer melt comprising blowing agent. Suitable blowing agents are the physical blowing agents usually used in EPS, such as aliphatic hydrocarbons having from 2 to 7 carbon atoms, alcohols, ketones, ethers, or halogenated hydrocarbons. Preference is given to use of isobutane, n-butane, isopentane, n-pentane.

To improve foamability, finely dispersed droplets of internal water may be introduced into the styrene polymer matrix. An example of the method for this is the addition of water into the molten styrene polymer matrix. The location of addition of the water may be upstream of, together with, or downstream of, the blowing agent feed: Homogeneous distribution of the water may be achieved by using dynamic or static mixers.

An adequate amount of water, based on the styrene polymer, is generally from 0 to 2% by weight, preferably from 0.05 to 1.5% by weight.

Expandable styrene polymers (EPSs) with at least 90% of the internal water in the form of droplets of internal water with diameter in the range from 0.5 to 15 μm form, on foaming, foams with an adequate number of cells and with homogeneous foam structure.

The amount added of blowing agent and of water is selected in such a way that the expansion capability a of the expandable styrene polymers (EPSs), defined as bulk density prior to foaming/bulk density after foaming, is at most 125, preferably from 25 to 100.

The bulk density of the inventive expandable pelletized styrene polymer materials (EPSs) is generally at most 700 g/l preferably in the range from 590 to 660 g/l. If fillers are used, bulk densities in the range from 590 to 1200 g/l may arise, depending on the nature and amount of the filler.

Additives, nucleating agents, fillers, plasticizers, flame retardants, soluble and insoluble inorganic and/or organic dyes and pigments, e.g. IR absorbers, such as carbon black, graphite, or aluminum powder may moreover be added, together or with spatial separation, to the styrene polymer melt, e.g. by way of mixers or ancillary extruders. The amounts added of the dyes and pigments are generally in the range from 0.01 to 30% by weight, preferably in the range from 1 to 5% by weight. For homogeneous and microdisperse distribution of the pigments within the styrene polymer, it can be advantageous, particularly in the case of polar pigments, to use a dispersing agent, e.g. organosilanes, polymers containing epoxy groups, or maleic-anhydride-grafted styrene polymers. Preferred plasticizers are mineral oils, low-molecular-weight styrene polymers and phthalates, which may be used in amounts of from 0.05 to 10% by weight, based on the styrene polymer.

To prepare the inventive expandable styrene polymers, the blowing agent is mixed into the polymer melt. The process encompasses the stages of a) melt production, b) mixing, c) cooling, d) transport, and e) pelletizing. Each of these stages may be executed using the apparatus or combinations of apparatus known from plastics processing. Static or dynamic mixers, such as extruders, are suitable for this mixing process. The polymer melt may be taken directly from a polymerization reactor, or produced directly in the mixing extruder, or in a separate melting extruder via melting of polymer pellets. The cooling of the melt may take place in the mixing assemblies or in separate coolers. Examples of pelletizers which may be used are pressurized underwater pelletizers, the pelletizer with rotating knives and cooling via spray-misting of temperature-control liquids, or pelletizers involving atomization. Examples of suitable arrangements of apparatus for carrying out the process are:

a) polymerization reactor—static mixer/cooler—pelletizer

b) polymerization reactor—extruder—pelletizer

c) extruder—static mixer—pelletizer

d) extruder—pelletizer

The arrangement may also have ancillary extruders for introducing additives, e.g. solids or heat-sensitive additives.

The temperature of the styrene polymer melt comprising blowing agent when it is passed through the die plate is generally in the range from 140 to 300° C., preferably in the range from 160 to 240° C. Cooling to the region of the glass transition temperature is not necessary.

The die plate is heated at least to the temperature of the polystyrene melt comprising blowing agent. The temperature of the die plate is preferably above the temperature of the polystyrene melt comprising blowing agent by from 20 to 100° C. This avoids polymer deposits in the dies and ensures problem-free pelletization.

In order to obtain marketable pellet sizes, the diameter (D) of the die holes at the discharge from the die should be in the range from 0.2 to 1.5 mm, preferably in the range from 0.3 to 1.2 mm, particularly preferably in the range from 0.3 to 0.8 mm. Even after die swell, this permits controlled setting of pellet sizes below 2 mm, in particular in the range from 0.4 to 1.4 mm.

Die swell can be affected not only by the molecular weight distribution but also by the geometry of the die. The die plate preferably has holes with an L/D ratio of at least 2, where the length (L) indicates that region of the die whose diameter is at most the diameter (D) at the discharge from the die. The L/D ratio is preferably in the range from 3-20.

The diameter (E) of the holes at the entry to the die in the die plate should generally be at least twice as large as the diameter (D) at the discharge from the die.

One embodiment of the die plate has holes with conical inlet and an inlet angle α smaller than 180°, preferably in the range from 30 to 120°. In another embodiment, the die plate has holes with a conical outlet and an outlet angle β smaller than 90°, preferably in the range from 15 to 45°. In order to produce controlled pellet size distributions in the styrene polymers, the die plate may be equipped with holes of different discharge diameter (D). The various embodiments of die geometry may also be combined with one another.

One particularly preferred process for preparing expandable styrene polymers encompasses the steps of
a) polymerization of styrene monomer and, where appropriate, of copolymerizable monomers, to give styrene copolymers A) or polystyrene B),
b) devolatilization of the resultant styrene polymer melt,
c) mixing with styrene copolymers A) or with thermoplastic polymers C),
d) using a static or dynamic mixer at a temperature of at least 150° C., preferably from 180 to 260° C., to mix the blowing agent and, where appropriate, additives, into the styrene polymer melt,
e) cooling the styrene polymer melt comprising blowing agent to a temperature of at least 120° C., preferably from 150 to 200° C.,
f) discharge via a die plate with holes whose diameter at the discharge from the die is at most 1.5 mm, and
g) pelletizing the melt comprising blowing agent.

The pelletizing process in step g) may take place directly downstream of the die plate under water at a pressure in the range from 1 to 25 bar, preferably from 5 to 15 bar.

Because of the polymerization in stage a) and devolatilization in stage b), a polymer melt is directly available for blowing agent impregnation in stage c), and no melting of styrene polymers is necessary. This is not only more cost-effective, but also gives expandable styrene polymers (EPSs) with low styrene monomer contents, because it avoids exposure to mechanical shear in the homogenizing section of an extruder—exposure which generally leads to breakdown of polymers to give monomers. In order to keep the styrene monomer content low, in particular below 500 ppm, it is also advantageous to minimize the amount of mechanical and thermal energy introduced in all of the subsequent stages of the process. Particular preference is therefore given to shear rates below 50/sec, preferably from 5 to 30/sec, and temperatures below 260° C., and also to short residence times in the range from 1 to 20 minutes, preferably from 2 to 10 minutes, in stages c) to e). It is particularly preferable to use exclusively static mixers and static coolers in the entire process. The polymer melt may be transported and discharged via pressure pumps, e.g. gear pumps.

Another method of reducing styrene monomer content and/or residual solvent, such as ethylbenzene, consists in providing a high level of devolatilization in stage b), using entrainers, such as water, nitrogen, or carbon dioxide, or carrying out the polymerization stage a) by an anionic route. Anionic polymerization of styrene not only gives styrene polymers with low styrene monomer content but also gives very low styrene oligomer contents.

To improve processability, the finished expandable pelletized styrene polymer materials may be coated by glycerol esters, antistatic agents, or anticaking agents.

The inventive expandable pelletized thermoplastic polymer materials may be prefoamed in a first step by means of hot air or steam to give foam beads whose density is in the range from 8 to 100 g/l, and may be fused in a 2nd step in a closed mold.

### EXAMPLES

Starting Materials:

| | |
|---|---|
| PS: | Glass-clear polystyrene (GPPS) with a viscosity number VN |
| | of 75 ml/g (M_{w} = 185 000 g/mol, polydispersity |
| | M_{w}/Mₙ = 2.6) from BASF Aktiengesellschaft |
| SAN 1 | Styrene-acrylonitrile copolymer (Luran ® VLL 1970 from |
| | BASF Aktiengesellschaft) |
| SAN 2 | Styrene-acrylonitrile copolymer (Luran ® VLS from BASF |
| | Aktiengesellschaft) |
| ABS 1 | Acrylonitrile-butadiene-styrene copolymer (Terluran |
| | GP 22 from BASF Aktiengesellschaft) |
| ABS 2 | Acrylonitrile-butadiene-styrene copolymer (Terluran |
| | HI 10 from BASF Aktiengesellschaft) |
| PP | Polypropylene (Novolen ® HP 501 H) |
| SB 1 | Styrene-butadiene star-block copolymer (Styrolux ® 3G55 |
| | from BASF Aktiengesellschaft) |
| SB2 | Styrene-butadiene block copolymer (Styrolux ® 2G66 from |
| | BASF Aktiengesellschaft) |
| SB3 | Styrene-butadiene block copolymer (Styrolux ® 684 D |
| | from BASF Aktiengesellschaft) |

For the examples, use was made of a melt mixture composed of glass-clear polystyrene and of polymers as given in the table below, and 6% by weight of n-pentane, based on the melt mixture, were also mixed into this mixture. The melt mixture comprising blowing agent was cooled from an initial 260° C. to 200° C., and passed, at throughput 60 kg/h, through a die plate with 32 holes (die diameter 0.75 mm). A compact pelletized material with narrow size distribution was prepared with the aid of pressurized underwater pelletization. The pentane content in the pelletized material was measured directly after extrusion and after 14 days of storage in a sealed polythene bag.

These pelletized materials were prefoamed in a current of steam to give foam beads, kept in intermediate storage for 12 hours, and then fused in gas-tight molds using steam, to give foams.

TABLE 1

| | Melt mixture | | |
|---|---|---|---|
| | composition | Pentane content | Pentane content |
| Example | [% by weight] | [% by weight] | 14d [% by weight] |
| 1 | PS/SB1 80/20 | 5.0 | 4.6 |
| 2 | PS/SB1 60/40 | 4.8 | 4.1 |
| 3 | PS/SB2 80/20 | 5.0 | 4.2 |
| 4 | PS/SB2 60/40 | 4.9 | 3.9 |
| 5 | PS/SB3 80/20 | 5.0 | 4.8 |
| 6 | PS/SB3 60/40 | 4.9 | 4.4 |
| 7 | PS/SAN 1 90/10 | 5.2 | 5.1 |
| 8 | PS/SAN 1 80/20 | 5.2 | 5.0 |
| 9 | PS/PP 90/10 | 5.0 | 4.5 |
| 10 | PS/PP 80/20 | 5.1 | 4.4 |

TABLE 2

| Example | Polymer | Foaming time [min] | Foam density [g/l] |
|---|---|---|---|
| 11 | SAN 2 | 12 | 88 |
| 12 | ABS 1 | 8 | 55 |
| 13 | ABS 2 | 8 | 52 |

TABLE 3
Foaming performance of expanded pelletized polymer materials
from examples 1, 3, 7-10 (bulk density [g/l])

| Foaming time | | | | | | |
|---|---|---|---|---|---|---|
| [sec] | E 1 | E 3 | E 7 | E 8 | E 9 | E 10 |
| 2 | | | 21.7 | 21.7 | | |
| 4 | 23.8 | | 14.7 | 15.2 | 19.2 | 50.0 |
| 6 | 22.7 | 45 | 16.7 | 16.7 | 17.2 | 45.5 |
| 8 | 21.7 | 40 | 19.2 | 19.2 | 16.7 | 50.0 |
| 10 | 22.7 | 36 | | | 19.2 | |
| 12 | | 45 | | | 21.7 | |
| 10 | | | | | | |

1. A moldable-foam molding with a density from 8 to 100 g/l, said molding obtainable via fusion of prefoamed foam beads comprising expandable, pelletized thermoplastic polymer materials, said polymer materials comprising;
from 50 to 90% by weight of polystyrene B selected from free-radical-polymerized glass-clear polystyrene (GPPS) or anionically polymerized polystyrene (APS), and
from 10 to 50% by weight of styrene copolymer A selected from styrene-butadiene block copolymer, styrene-α-methylstyrene copolymer, acrylonitrile-butadiene-styrene (ABS), styrene-acrylonitrile (SAN), acrylonitrile-styrene-acrylate (ASA), methacrylate-butadiene-styrene (MBS), or methyl methacrylate-acrylonitrile-butadiene-styrene (MABS) polymers.

2. The moldable-foam molding according to claim 1, wherein at least 80% of the cells of the foam beads are of closed-cell type.

3. An expandable, pelletized thermoplastic polymer material which comprises;
from 50 to 90% by weight of polystyrene B selected from free-radical-polymerized glass-clear polystyrene (GPPS) or anionically polymerized polystyrene (APS), and
from 10 to 50% by weight of styrene copolymer A selected from styrene-butadiene block copolymer, styrene-α-methylstyrene copolymer, acrylonitrile-butadiene-styrene (ABS), styrene-acrylonitrile (SAN), acrylonitrile-styrene-acrylate (ASA), methacrylate-butadiene-styrene (MBS), or methyl methacrylate-acrylonitrile-butadiene-styrene (MABS) polymers.

4. The expandable, pelletized thermoplastic polymer material according to claim 3, further comprising from 3 to 7% by weight of an organic blowing agent.

5. A process for preparing expandable, pelletized thermoplastic polymer materials according to claim 3, comprising the steps of;
a) preparing a mixture from 50 to 90% by weight of polystyrene B selected from free-radical-polymerized glass-clear polystyrene (GPPS) or anionically polymerized polystyrene (APS), and from 10 to 50% by weight of styrene copolymer A selected from styrene-butadiene block copolymer, styrene-α-methylstyrene copolymer, acrylonitrile-butadiene-styrene (ABS), styrene-acrylonitrile (SAN), acrylonitrile-styrene-acrylate (ASA), methacrylate-butadiene-styrene (MBS), or methyl methacrylate-acrylonitrile-butadiene-styrene (MABS) polymers;
b) heating the mixture using a static or dynamic mixer at a temperature of at least 150° C. to form a polymer melt, and adding an organic blowing agent to the melt;
c) cooling the polymer melt comprising blowing agents to a temperature of at least 120° C.,
d) discharging the cooled melt through a die with holes whose diameter is at most 1.5 mm, and
e) pelletizing the melt comprising blowing agent downstream of the die plate under water at a pressure from 1 to 20 bar.

6. A process for producing moldable-foam moldings, according to claim 1, wherein hot air or steam is used in a first step to prefoam expandable, pelletized thermoplastic polymer materials according to claim 3 to give foam beads whose density is in the range from 8 to 100 g/l, and, in a second step, the polymer materials are fused in a closed mold.

7. A process for making foam molding comprising injecting hot air or steam into a polymer mixture comprising from 50 to 90% by weight of polystyrene B selected from free-radical-polymerized glass-clear polystyrene (GPPS) or anionically polymerized polystyrene (APS), and from 10 to 50% by weight of styrene copolymer A selected from styrene-butadiene block copolymer, styrene-α-methylstyrene copolymer, acrylonitrile-butadiene-styrene (ABS), styrene-acrylonitrile (SAN), acrylonitrile-styrene-acrylate (ASA), methacrylate-butadiene-styrene (MBS), or methyl methacrylate-acrylonitrile-butadiene-styrene (MABS) polymers to form beads with a density from 8 to 100 g/L, the process comprising:
heating the mixture using a static or dynamic mixer at a temperature of at least 150° C. to form a polymer melt, and adding an organic blowing agent to the melt;
cooling the polymer melt comprising blowing agents to a temperature of at least 120° C.;
discharging the cooled melt through a die with holes whose diameter is at most 1.5 mm; and
pelletizing the melt comprising blowing agent downstream of the die plate under water at a pressure from 1 to 20 bar.

8. The process of claim 7, wherein the polymer mixture has a Mw from 190,000 to 400,000 g/mol.

9. The polymer material of claim 3, wherein the polymer mixture has a Mw from 190,000 to 400,000 g/mol.

10. The process of claim 7, wherein the polymer mixture has a polydispersity Mw/Mn of at most 3.5 or less.

11. The process of claim 10, wherein the polydispersity is from 1.5 to 2.8.

12. The polymer material of claim 3, with a polydispersity Mw/Mn of from 1.5 to 2.8.
